(19) United States
(12) Patent Application Publication
(10) Pub. No.: US 2006/0152531 A1
(43) Pub. Date: Jul. 13, 2006

(54) Method and system for driving pixel in active matrix display

(76) Inventors: Lichi Lin, Chiayi (TW); Yuhsiang Lin, Taipei (TW)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 11/328,675

(22) Filed: Jan. 10, 2006

(30) Foreign Application Priority Data
Jan. 12, 2005 (TW) 094100902

(51) Int. Cl. G09G 5/00

(52) U.S. Cl. 345/613

(57) ABSTRACT

A pixel driving system in an active matrix display is provided. The system includes a first sub-pixel including a first transparent area and a first drive circuit area, and a second sub-pixel including a second transparent area and a second drive circuit area, in which the first drive circuit area is electrically connected to the second transparent area so as to drive the second sub-pixel for light-emitting, and the second drive circuit area is electrically connected to the first transparent area so as to drive the first sub-pixel for light-emitting. Further, a method for driving a pixel in an active matrix display is also provided.

### FIELD OF THE INVENTION

The present invention is related to a method and a system for driving a pixel, and more particularly to a method and a system for driving a pixel to enhance the luminous brightness on the pixel in an active matrix display.

### BACKGROUND OF THE INVENTION

Up to the present, the display (or “monitor”) has played an important role for communicating between the human and machine because the personal computer (PC), the network and other information medium have gained popularity with the technological progress. Further, the display industry has made substantially progress with the continuous research and development therefor. Thus, the novel display technologies such as a plasma display panel (PDP) and a liquid crystal display (LCD) which include a bigger, thinner and lighter size have substituted for the conventional cathode ray tube (CRT) monitor with a heavier and hunger volume.

Nowadays, a new technique “organic light-emitting diode (OLED)” is drawing much attention in the present consumer market among various developing flat panel display (FDP) technologies. Further, the organic light-emitting diode (OLED) is the organic light-emitting Display (OLED) and also called “Organic Electroluminescence (OEL)”. The display made by this OLED technique includes many advantages, such as a thinner and lighter size, a more flexible plane, an easier portability, a higher luminous brightness, a lower power consumption, a wider viewing angle, and no afterimage, and these advantages have become a new trend in the FDP filed. Thus, people in the academic or the industrial field have invested a lot of time to research and develop this developing display technology.

Generally, the OLED display can be divided into a passive matrix type and an active matrix type according to its driving form. Moreover, the active matrix type is one driving type which uses the thin film transistors (TFT) with capacitors for storing signals to control the brightness and gray level on the OLED.

Please refer to FIG. 1, which is a schematic view showing a conventional layout of pixels in an active matrix OLED, in which each pixel 10 includes three different sub-pixels 11, 12 and 13. The sub-pixels 11, 12 and 13 are used for respectively emitting three primary colors including a red color, a green color and a blue color (RGB), and emit different full-colors according to different mixing ratios thereof. Presently, each pixel 10 has the same size, and the sub-pixels 11, 12 and 13 have an identical size with the same transparent electrodes 111, 121 and 131 and the same TFT circuits 112, 122 and 132. In FIG. 1, the sub-pixel 11 is a red sub-pixel 11 for emitting the red color and the sub-pixel 12 is a green sub-pixel 12 for emitting the green color. However, the red sub-pixel 11 includes a relatively lower luminous efficacy and the green sub-pixel 12 includes a relatively higher luminous efficacy based on the present technical development. Accordingly, the brightness of one light-emitting material including a relatively higher luminous efficacy such as the green sub-pixel 12 would be decreased to match with the other light-emitting material including a relatively lower luminous efficacy such as the red sub-pixel 11 according to the above-mentioned layout. Then, the brightness in this display would be decreased.

According to the general optoelectronics principle, there are some parameters related to the brightness of this display, such as the ratio of light-emitting area and sub-pixel area (γ), the current density (I/A_{ITO}) and the luminous efficacy of the organic light-emitting material (η). The relationship among these parameters is as following:
B_{(Pixel)}∝γ×η×(I/A_{ITO})
γ=A_{ITO}/A_{Pixel}
A_{Pixel}=A_{TFT}+A_{ITO}
The brightness seen from eyes=B₍ₚᵢₓₑₗ₎×γ
where B_{Pixel)} is the brightness of the pixel, A_{Pixel} is the area of the sub-pixel, A_{ITO} is the area of indium tin oxide (ITO) in the sub-pixel, and A_{TFT} is the area of TFT in the sub-pixel.

According to the above-mentioned relationship, it is considered that the size of the effective ratio of light-emitting area (γ) in each sub-pixel would determine the magnitude of brightness in the display when the areas of the sub-pixels are fixed. Nevertheless, the effective light-emitting area of each sub-pixel is greater and then the brightness in the display is greater if the effective light-emitting area of each pixel includes the same brightness. Besides, the brightness in the display is greater while the effective light-emitting area of each sub-pixel is smaller.

Furthermore, the only way for adding an outputting current in the present TFT without changing its material is to add a depth-to-width ratio (W/L) of a transistor channel in the TFT. Because the depth (L) of the transistor channel includes a minimum limit in the TFT manufacturing process, more current could be obtained by adding the width (W) of the transistor channel in the TFT. However, the area of the TFT would be increased while the width of the transistor channel is added. Accordingly, the effective light-emitting area of the sub-pixels in the display would be decreased therewith.

Moreover, the product of the luminous efficacy of the organic light-emitting material (η) and the current density is the luminous brightness in the effective light-emitting area. In addition, it is considered that the light-emitting materials for emitting three primary colors (RGB) include different luminous efficacy. Thus, the color level and the brightness in the display are often limited to its light-emitting material with a relatively lower luminous efficacy. Take an example, the light-emitting material for emitting the red color usually includes a relatively lower luminous efficacy and then the higher brightness therein would be achieved by providing more current generated form the TFT. However, more current generated from the TFT would be achieved by providing more area of the TFT circuit. Accordingly, the brightness in the red sub-pixel 11 encounters a limit if the area of the sub-pixel is fixed.

Recently, another research for improving the pixel layout in the display has been disclosed. Please refer to FIG. 2, which is a schematic view showing a conventional layout of pixels where different areas in the sub-pixels would be provided according to different luminous efficacy from different light-emitting materials. In FIG. 2, each pixel 20 includes a red sub-pixel 21, a green sub-pixel 22 and a blue sub-pixel 23. The red sub-pixel 21 with a relatively lower luminous efficacy includes a maximum area so that the brightness in the red sub-pixel 21 is increased. The green sub-pixel 22 with a relatively higher luminous efficacy includes a minimum area so that the brightness in the green sub-pixel 22 is decreased. Further, the blue sub-pixel 23 with a medium luminous efficacy between the red sub-pixel 21 and the green sub-pixel 22 includes a medium area therebetween.

However, such layout for changing the sizes of sub-pixels still includes the following drawbacks. The pixel 20 often includes one red sub-pixel 21, one green sub-pixel 22 and one blue sub-pixel 23. If the area of the red sub-pixel 21 is increased, the entire area of the pixel 20 would be increased therewith and greater than the area of the pixel 10 shown in FIG. 1. Finally, the display includes less number of pixels 20 and the resolution in the display would be decreased. Further, a less area of the green sub-pixel 22 decreases the γ value of the green sub-pixel 22 and the brightness in the green sub-pixel 22 would be decreased therewith.

Moreover, the light-emitting material operated under a higher current density often includes a shorter luminous half-life than those under a lower current density. A standard for a best display should include a light-emitting material with a less luminous half-life and a lower luminous efficacy to have a greater effective light-emitting area. However, it would be quite difficult to achieve the above standard because of less light-emitting area and less driving current according to the conventional layout.

Therefore, the purpose of the present invention is to develop a method and a system to deal with the above situations encountered in the prior art.

### SUMMARY OF THE INVENTION

It is therefore a first aspect of the present invention to provide a method and a system for driving a plurality of pixels in an active matrix display, in which two sub-pixels with different luminous efficacy are electrically connected with each other so as to drive one sub-pixel with a relatively lower luminous efficacy for light-emitting by a drive circuit in another sub-pixel with a relatively higher luminous efficacy, whereby enhancing the brightness of the sub-pixel with a relatively lower luminous efficacy.

It is therefore a second aspect of the present invention to provide a method and a system for driving a plurality of pixels in an active matrix display including a specific layout of sub-pixels in single pixel to enhance the brightness and the lifetime in the display without changing the sizes of the sub-pixels in the single pixel.

According to an aspect of the present invention, a method for driving a plurality of pixels in an active matrix display is provided, in which each of the pixels includes a first and a second sub-pixels with different luminous efficacy for emitting different colors, and each of the sub-pixel includes a transparent area and a drive circuit area. The method includes steps of (a) increasing a first transparent area on the first sub-pixel with a relatively lower luminous efficacy, and decreasing a first drive circuit area on the first sub-pixel with a relatively lower luminous efficacy, so as to decrease a first driving current generated from the first drive circuit area, (b) decreasing a second transparent area on the second sub-pixel with a relatively higher luminous efficacy, and increasing a second drive circuit area on the second sub-pixel with a relatively higher luminous efficacy, so as to increase a second driving current generated from the second drive circuit area, (c) electrically connecting the first drive circuit area and the second transparent area, so as to drive the second sub-pixel for light-emitting by the first drive circuit area, and (d) electrically connecting the second drive circuit area and the first transparent area, so as to drive the first sub-pixel for light-emitting by the second drive circuit area.

Preferably, the first and second drive circuit areas are circuits having at least one thin film transistor (TFT) for generating the first and second driving currents.

Preferably, the step (a) is performed by decreasing a depth-to-width ratio (W/L) of a transistor channel in the TFT, so as to provide a relatively lower current density of the first driving current.

Preferably, the step (b) is performed by increasing a depth-to-width ratio (W/L) of a transistor channel in the TFT, so as to provide a relatively higher current density of the second driving current.

Preferably, the first and second sub-pixels further include different light-emitting materials for emitting different color lights.

Preferably, the first and second transparent areas are transparent electrodes respectively covered with the emitting materials for emitting different color lights, and the transparent electrodes are made of a indium tin oxide (ITO) conductive glass.

Preferably, the active matrix display is an active matrix organic light-emitting diode (AM-OLED).

Preferably, the active matrix organic light-emitting diode is one of a small organic molecular light-emitting diode (OLED) and a polymer organic molecular light-emitting diode (PLED).

Preferably, the pixel further includes a third sub-pixel and the sub-pixels are used for emitting primary colors including a red color, a green color and a blue color (RGB), respectively.

Preferably, the first sub-pixel including a relatively lower luminous efficacy is a red sub-pixel for emitting the red color and the second sub-pixel including a relatively higher luminous efficacy is a green sub-pixel for emitting the green color.

Preferably, the steps (c) and (d) are performed by electrically connecting the first sub-pixel to the second sub-pixels through conductive layers with different levels via a pixel forming process.

Preferably, the steps (c) and (d) are performed by exchanging a layout of the first drive circuit area for that of the first transparent area.

Preferably, the steps (c) and (d) are performed by exchanging a layout of the second drive circuit area for that of the second transparent area.

Preferably, the sub-pixels have an identical size.

According to another aspect of the present invention, a pixel driving system in an active matrix display is provided. The system includes a first sub-pixel including a first transparent area and a first drive circuit area, and a second sub-pixel including a second transparent area and a second drive circuit area, wherein the first drive circuit area is electrically connected to the second transparent area so as to drive the second sub-pixel for light-emitting, and the second drive circuit area is electrically connected to the first transparent area so as to drive the first sub-pixel for light-emitting.

Preferably, the system further includes a third sub-pixel to form a pixel having the first sub-pixel, the second sub-pixel and the third sub-pixel.

Preferably, the first, second and third sub-pixels include different emitting materials for emitting different colors, respectively.

Preferably, a luminous efficacy of the third sub-pixel is greater than that of the first sub-pixel and a luminous efficacy of the second sub-pixel is greater than that of the third sub-pixel.

Preferably, the first, second and third sub-pixels have an identical size.

Preferably, the second drive circuit area is greater than the first drive circuit area, so that a second driving current generated from the second drive circuit area is greater than a first driving current generated from the first drive circuit area.

Preferably, the first transparent area is greater than the second transparent area.

Preferably, the first transparent area is opposite to the second drive circuit area and second transparent area is opposite to the first drive circuit area.

Preferably, the first transparent area is opposite to the second transparent area and first drive circuit area is opposite to the second drive circuit area.

Preferably, the colors include three primary colors having a red color, a green color and a blue color (RGB).

According to another aspect of the present invention, a method for driving a pixel in an active matrix display is provided, in which the pixel includes a first, a second and a third sub-pixels with different luminous efficacy for emitting different colors. The method includes steps of driving a first sub-pixel with a relatively lower luminous efficacy for light-emitting by a second drive circuit of a second sub-pixel with a relatively higher luminous efficacy, and driving the second sub-pixel including a highest for light-emitting by a first drive circuit of the first sub-pixel.

Preferably, the method further includes a step of increasing a second driving current generated from the drive circuit of the second sub-pixel.

Preferably, the step of increasing the second driving current is performed by increasing an area of the second drive circuit of the second sub-pixel.

Preferably, the method further includes a step of decreasing a first driving current generated from the first drive circuit of the first sub-pixel.

Preferably, the step of decreasing the first driving current is performed by decreasing an area of the first drive circuit of the first sub-pixel.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic view showing a first conventional layout of pixels in an active matrix organic light-emitting diode (AM-OLED);

FIG. 2 is a schematic view showing a second conventional layout of pixels in an active matrix organic light-emitting diode (AM-OLED);

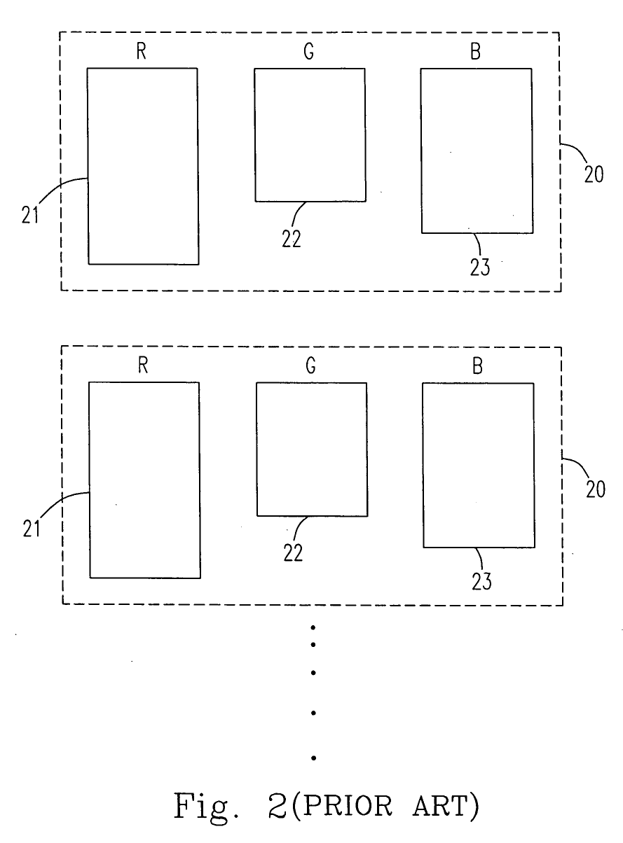

FIG. 3 is a schematic view showing a layout of single pixel in an active matrix display according to a first preferred embodiment of the present invention; and

FIG. 4 is a schematic view showing a layout of single pixel in an active matrix display according to a second preferred embodiment of the present invention.

### DETAILED DESCRIPTION OF THE PREFERRED EMBODIMENTS

The present invention will now be described more specifically with reference to the following embodiment. It is to be noted that the following descriptions of preferred embodiment of this invention are presented herein for purposes of illustration and description only; it is not intended to be exhaustive or to be limited to the precise form disclosed.

Different light-emitting materials respectively include different luminous efficacy in the present active display, so that the brightness in a respective sub-pixel of a single pixel is not identical. Thus, the brightness in the single pixel would be decreased because of the brightness in one sub-pixel with a relatively lower luminous efficacy. Therefore, the present invention would be implemented by re-configuring the driving layout of the sub-pixels in the single pixel to effectively enhance the brightness in the sub-pixels with different luminous efficacy, thereby enhancing the brightness in the display.

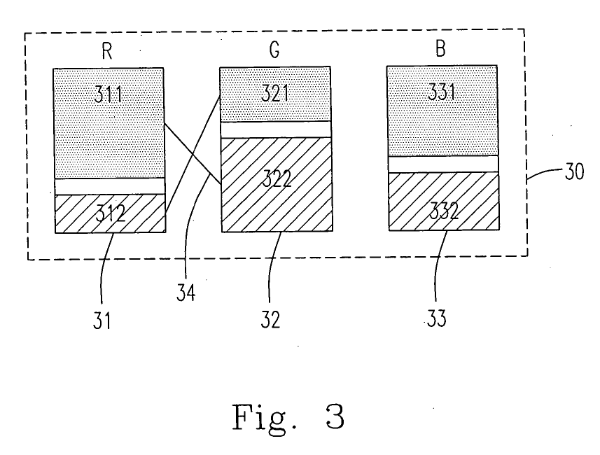

Please refer to FIG. 3, which is schematic view showing a layout of single pixel in an active matrix display according to a first preferred embodiment of the present invention. To simplify the illustration, only a single pixel 30 is shown in FIG. 3. The pixel 30 includes the sub-pixels 31, 32 and 33 with an identical size, wherein the sub-pixel 31 is a red sub-pixel 31 for emitting a red color (R), the sub-pixel 32 is a green sub-pixel 32 for emitting a green color (G), and the sub-pixel 33 is a blue sub-pixel 33 for emitting a green color (B). The color combination of three primary colors having the red color, the green color and the blue color (RGB) disclosed in the present invention is the basic light-emitting standard. However, the present invention could also be applied to additional sub-pixels for emitting different colors to form a new color combination, such as a color combination of RGBCMY colors having the RGB primary colors with the subtractive primary colors of a cyan color, a magenta color and a yellow color (CMY) or a color combination of RGBE colors having the RGB primary colors with an emerald color (E).

Further, the red sub-pixel 31 includes a first transparent area 311 and a first drive circuit area 312, the green sub-pixel 32 includes a second transparent area 321 and a second drive circuit area 322, and the blue sub-pixel 33 includes a third transparent area 331 and a third drive circuit area 332. According to the current technical development, the light-emitting material of the red sub-pixel 31 includes a relatively lower luminous efficacy, the light-emitting material of the green sub-pixel 32 includes a relatively higher luminous efficacy, and the light-emitting material of the blue sub-pixel 33 includes a medium luminous efficacy between that of the red sub-pixel 31 and the green sub-pixel 32. Therefore, the first transparent area 311 on the red sub-pixel 31 would be increased and the second transparent area 321 on the green sub-pixel 31 would be decreased so that the first drive circuit area 312 is smaller than the second drive circuit area 322 because the sub-pixels 31 and 32 include an identical size.

According to the above descriptions, the first, second and third drive circuit areas 312, 322 and 332 disclosed in the present invention are embodied as drive circuits, and each of the drive circuit includes at least one thin film transistor (TFT). When the area of the drive circuit is increased, a depth-to-width ratio (W/L) of a transistor channel in the TFT would be increased so as to generate a relatively higher current density of the driving current. Besides, a relatively lower current density of the driving current would be generated when the area of the drive circuit is decreased, i.e. a depth-to-width ratio (W/L) of a transistor channel in the TFT is decreased.

Therefore, the first drive circuit area 312 is electrically connected to the second transparent area 321 via a connection 34, so as to drive the green sub-pixel 32 for light-emitting by the first drive circuit area 312. Further, the second drive circuit area 322 is electrically connected to the first transparent area 311 via a connection 34, so as to drive the red sub-pixel 31 for light-emitting by the second drive circuit area 322.

Furthermore, the first, second and third transparent areas 311, 321 and 331 are transparent electrodes respectively covered with the light-emitting materials for emitting different color lights (primary RGB colors), and the transparent electrodes are made of an indium tin oxide (ITO) conductive glass. Further, the active matrix display is an active matrix organic light-emitting diode (AM-OLED) and the active matrix organic light-emitting diode is one of a small organic molecular light-emitting diode (OLED) and a polymer organic molecular light-emitting diode (PLED).

Thus, the drive circuit of the second drive circuit area 322 on the second sub-pixel 32 with the relatively higher luminous efficacy would drive the transparent electrode of the first transparent area 311 on the first sub-pixel 31 with the relatively lower luminous efficacy for light-emitting according to the above descriptions. Moreover, such driving layout would not be limited within the single sub-pixel so that the degree of freedom for adjusting the area of the drive circuit or the transparent electrode on the sub-pixel is greater than that in the conventional layout.

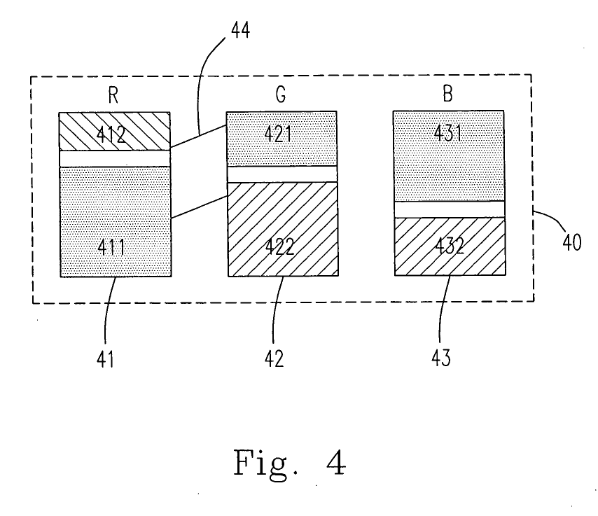

Furthermore, the driving layout of the connection 34 between two sub-pixels 31 and 32 would be performed by electrically connecting the sub-pixels 31 and 32 through conductive layers (not shown) with different levels via a pixel forming process in order to interfere with each other. In addition, it could be implemented by exchanging the opposite layouts of the sub-pixels 31 and 32, as shown in FIG. 4

FIG. 4 is a schematic view showing a layout of single pixel in an active matrix display according to a second preferred embodiment of the present invention. The structure or layout of sub-pixels 41, 42 and 43, i.e. a red sub-pixel 41, a green sub-pixel 42 and a blue sub-pixel 43, in FIG. 4 is similar to that in FIG. 3, except the layout of the red sub-pixel 41 is reversed. Further, a first transparent area 411 of the red sub-pixel 41 is opposite to a second drive circuit area 422 of the green sub-pixel 42, and a second transparent area 421 of the green sub-pixel 42 is opposite to a first drive circuit area 412 of the red sub-pixel 41. Thus, two neighboring sub-pixels 41 and 42 could be exchanged to use the drive circuit areas 412 and 422 via the connection 44. A drive current generated from the first drive circuit area 412 on the red sub-pixel 41 could drive the second transparent area 421 on the green sub-pixel 42 for light-emitting via the connection 44, which are easily performed without adding any manufacturing process.

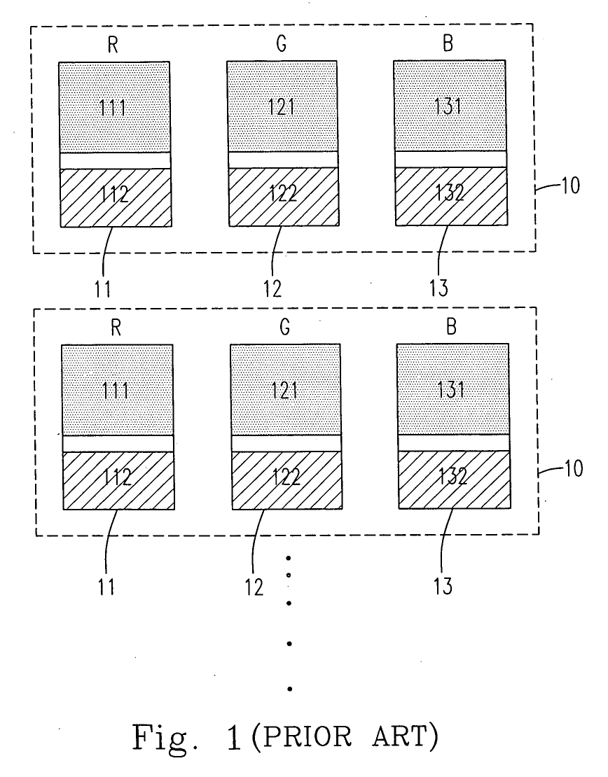

Therefore, the brightness and the lifetime on the display could be effectively enhanced by applying the above sub-pixel layout with adjusting the sizes of the transparent area and the drive circuit area on the sub-pixels and electrically connecting each other. Further, the sub-pixel disclosed in the present invention and the conventional sub-pixel, i.e. the sub-pixel 10 disclosed in FIG. 1, include an identical size, and the space for configuring the pixels in the display would not be wasted. In addition, the driving current could be changed by adjusting different color levels with an external driving IC according to the present invention, and it could be possible to apply a driving IC of the LCD in the present invention. Thus, the manufacturing cost would be decreased therewith.

In conclusion, it is understood that the present method and system for driving the pixel in the active matrix display could apply two sub-pixels with different luminous efficacy electrically connecting with each other, so as to drive one sub-pixel with a relatively lower luminous efficacy for light-emitting by a drive circuit in another sub-pixel with a relatively higher luminous efficacy. Therefore, a higher brightness and a longer lifetime on the pixels of the display would be achieved by the present invention without any additional pixel manufacturing process and production cost.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for driving a plurality of pixels in an active matrix display, wherein each of said pixels includes a first and a second sub-pixels with different luminous efficacy for emitting different colors, and each of said sub-pixel includes a transparent area and a drive circuit area, comprising steps of:
(a) increasing a first transparent area on said first sub-pixel with a relatively lower luminous efficacy, and decreasing a first drive circuit area on said first sub-pixel with a relatively lower luminous efficacy, so as to decrease a first driving current generated from said first drive circuit area;
(b) decreasing a second transparent area on said second sub-pixel with a relatively higher luminous efficacy, and increasing a second drive circuit area on said second sub-pixel with a relatively higher luminous efficacy, so as to increase a second driving current generated from said second drive circuit area;
(c) electrically connecting said first drive circuit area and said second transparent area, so as to drive said second sub-pixel for light-emitting by said first drive circuit area; and
(d) electrically connecting said second drive circuit area and said first transparent area, so as to drive said first sub-pixel for light-emitting by said second drive circuit area.

2. The method according to claim 1, wherein said first and second drive circuit areas are circuits having at least one thin film transistor (TFT) for generating said first and second driving currents.

3. The method according to claim 2, wherein said step (a) is performed by decreasing a depth-to-width ratio (W/L) of a transistor channel in said TFT, so as to provide a relatively lower current density of said first driving current.

4. The method according to claim 2, wherein said step (b) is performed by increasing a depth-to-width ratio (W/L) of a transistor channel in said TFT, so as to provide a relatively higher current density of said second driving current.

5. The method according to claim 1, wherein said first and second sub-pixels further include different light-emitting materials for emitting different color lights.

6. The method according to claim 5, wherein said first and second transparent areas are transparent electrodes respectively covered with said emitting materials for emitting different color lights.

7. The method according to claim 6, wherein said transparent electrodes are made of a indium tin oxide (ITO) conductive glass.

8. The method according to claim 1, wherein said active matrix display is an active matrix organic light-emitting diode (AM-OLED).

9. The method according to claim 8, wherein said active matrix organic light-emitting diode is one of a small organic molecular light-emitting diode (OLED) and a polymer organic molecular light-emitting diode (PLED).

10. The method according to claim 1, wherein said pixel further includes a third sub-pixel and said sub-pixels are used for emitting primary colors including a red color, a green color and a blue color (RGB), respectively.

11. The method according to claim 10, wherein said first sub-pixel including a relatively lower luminous efficacy is a red sub-pixel for emitting said red color.

12. The method according to claim 10, wherein said second sub-pixel including a relatively higher luminous efficacy is a green sub-pixel for emitting said green color.

13. The method according to claim 1, wherein said steps (c) and (d) are performed by electrically connecting said first sub-pixel to said second sub-pixels through conductive layers with different levels via a pixel forming process.

14. The method according to claim 1, wherein said steps (c) and (d) are performed by exchanging a layout of said first drive circuit area for that of said first transparent area.

15. The method according to claim 1, wherein said steps (c) and (d) are performed by exchanging a layout of said second drive circuit area for that of said second transparent area.

16. The method according to claim 1, wherein said sub-pixels have an identical size.

17. A pixel driving system in an active matrix display, comprising:
a first sub-pixel including a first transparent area and a first drive circuit area; and
a second sub-pixel including a second transparent area and a second drive circuit area;
wherein said first drive circuit area is electrically connected to said second transparent area so as to drive said second sub-pixel for light-emitting, and said second drive circuit area is electrically connected to said first transparent area so as to drive said first sub-pixel for light-emitting.

18. The pixel driving system according to claim 17, further comprising a third sub-pixel to form a pixel having said first sub-pixel, said second sub-pixel and said third sub-pixel.

19. The pixel driving system according to claim 18, wherein said first, second and third sub-pixels include different emitting materials for emitting different colors, respectively.

20. The pixel driving system according to claim 19, wherein a luminous efficacy of said third sub-pixel is greater than that of said first sub-pixel.

21. The pixel driving system according to claim 20, wherein a luminous efficacy of said second sub-pixel is greater than that of said third sub-pixel.

22. The pixel driving system according to claim 21, wherein said first, second and third sub-pixels have an identical size.

23. The pixel driving system according to claim 22, wherein said second drive circuit area is greater than said first drive circuit area, so that a second driving current generated from said second drive circuit area is greater than a first driving current generated from said first drive circuit area.

24. The pixel driving system according to claim 22, wherein said first transparent area is greater than said second transparent area.

25. The pixel driving system according to claim 17, wherein said first transparent area is opposite to said second drive circuit area.

26. The pixel driving system according to claim 25, wherein said second transparent area is opposite to said first drive circuit area.

27. The pixel driving system according to claim 17, wherein said first transparent area is opposite to said second transparent area.

28. The pixel driving system according to claim 27, wherein said first drive circuit area is opposite to said second drive circuit area.

29. The pixel driving system according to claim 19, wherein said colors include three primary colors having a red color, a green color and a blue color (RGB).

30. A method for driving a pixel in an active matrix display, wherein said pixel includes a first, a second and a third sub-pixels with different luminous efficacy for emitting different colors, comprising steps of:
driving a first sub-pixel with a relatively lower luminous efficacy for light-emitting by a second drive circuit of a second sub-pixel with a relatively higher luminous efficacy; and
driving said second sub-pixel including a highest for light-emitting by a first drive circuit of said first sub-pixel.

31. The method according to claim 30, further comprising a step of increasing a second driving current generated from said drive circuit of said second sub-pixel.

32. The method according to claim 31, wherein said step of increasing said second driving current is performed by increasing an area of said second drive circuit of said second sub-pixel.

33. The method according to claim 30, further comprising a step of decreasing a first driving current generated from said first drive circuit of said first sub-pixel

34. The method according to claim 33, wherein said step of decreasing said first driving current is performed by decreasing an area of said first drive circuit of said first sub-pixel.
